(19) United States
(12) Patent Application Publication
(10) Pub. No.: US 2024/0120526 A1
(43) Pub. Date: Apr. 11, 2024

(54) METHOD FOR IMPROVING INTERFACE OF COMPOSITE SOLID ELECTROLYTE IN SITU

(71) Applicant: YANGTZE DELTA REGION INSTITUTE OF UNIVERSITY OF ELECTRONIC SCIENCE AND TECHNOLOGY OF CHINA, HUZHOU, Huzhou (CN)

(72) Inventors: Mengqiang WU, Chengdu (CN); Ziqiang XU, Chengdu (CN); Zixuan FANG, Chengdu (CN); Zhihao ZHANG, Chengdu (CN)

(21) Appl. No.: 18/108,911

(22) Filed: Feb. 13, 2023

(30) Foreign Application Priority Data
Sep. 20, 2022 (CN) 202211142892.X

(51) Int. Cl. H01M 10/056; H01M 4/36; H01M 4/38; H01M 4/58; H01M 4/62

(52) U.S. Cl. CPC H01M 10/056; H01M 4/366; H01M 4/382; H01M 4/5825; H01M 4/623; H01M 4/625; H01M 2004/028

(57) ABSTRACT

Disclosed is a method for improving an interface of composite solid electrolyte in situ relates to the field of composite solid electrolyte. By cooling and solidifying the first trans-crystalline solidified liquid, a first trans-gauche isomeric plastic crystal layer is constructed between the positive electrode and the composite solid electrolyte; by cooling and solidifying the second trans-crystalline solidified liquid, a second trans-gauche isomeric plastic crystal layer is constructed between the composite solid electrolyte and the negative electrode; the first trans-crystalline solidified liquid includes trans-gauche isomeric plastic crystals and lithium salt, and the second trans-crystalline solidified liquid includes trans-gauche isomeric plastic crystals, lithium salt and additives.

### CROSS-REFERENCE TO RELATED APPLICATIONS

This application claims priority to Chinese Patent Application No. 202211142892.X filed on Sep. 20, 2022, the contents of which are hereby incorporated by reference.

### TECHNICAL FIELD

The application relates to the technical field of composite solid electrolyte, and in particular to a method for improving an interface of composite solid electrolyte in situ.

### BACKGROUND

As the main force of energy conversion and storage devices, lithium-ion batteries are widely used in people's daily life. However, with the deepening of research, researchers found that the energy density of lithium-ion batteries has reached the limit, which can't meet the requirements of high endurance and long life of new energy vehicles. At the same time, the organic liquid electrolyte is flammable, and it is easy to form lithium dendrites to pierce the membrane after repeated cycles, which greatly threatens the safety of the battery. The use of solid electrolyte may introduce lithium metal cathode, reduce the use of electrolyte, and greatly improve the safety of battery. Although the pure ceramic solid electrolyte may be compatible with lithium positive electrode and effectively inhibit lithium dendrite, its natural rigidity brings great interfacial resistance, so it will take a long time for the actual commercialization. The composite electrolyte has both the flexibility of polymer and the rigidity of inorganic substance, which may restrain lithium dendrite and contact with electrode at the same time. However, in order to reduce the interface impedance of the battery, the existing composite solid electrolyte often needs to drop a little electrolyte to improve the interface contact, which can't completely avoid the use of electrolyte and still has potential safety hazards. At the same time, the composite solid-state electrolyte has high crystallinity at room temperature, few amorphous regions, and slow transmission of lithium ions through segment movement, so the assembled battery has high impedance at room temperature. At present, most of the composite solid-state batteries are tested at high temperature, and high temperature is used to reduce polymer crystallinity and battery impedance, which is inconsistent with practical application. How to completely eliminate the use of electrolyte and reduce the room temperature impedance of composite solid-state batteries is still a challenge.

### SUMMARY

The purpose of the present application is to provide a method for improving an interface of composite solid electrolyte in situ, aiming at the problems existing in the background technology. According to the application, the interface of the solid electrolyte is improved in situ by constructing the trans-gauche isomeric plastic crystal layer, and the trans-gauche isomeric molecule has the characteristic of central symmetry, and may rotate around the central C atom or C—C bond. Combined with the strong polar group of the plastic crystal (PC), the trans-gauche isomeric plastic crystal has strong dissociative performance to lithium salt, and the combination of the two has quite high ionic conductivity (10⁻³ S cm⁻¹), and the trans-crystalline solidified liquid is formed with additives in a reasonable proportion. By using the properties of trans-crystalline solidified liquid, which is liquid at high temperature and colloidal/solid at room temperature, the interface with the electrode is improved and the interface resistance is reduced by in-situ cooling and curing. At the same time, using the high dielectric constant and high polarity characteristics of trans-gauche isomeric plastic crystals, the crystallinity at the interface of the composite solid electrolyte is reduced, its amorphous region is increased, the transmission of lithium ions is promoted, and the impedance of the battery is greatly reduced. Compared with the battery without electrolyte dripping, the interface impedance of the composite solid electrolyte improved by the trans-gauche isomeric plastic crystal of the application is obviously reduced, the specific capacity and the cycle stability are obviously improved, and the composite solid electrolyte has excellent electrochemical performance.

To achieve the above purpose, the technical scheme adopted by the application is as follows:

A method for improving the interface of composite solid electrolyte in situ includes the following steps: cooling and solidifying a first trans-gauche isomeric plastic crystal layer between a positive electrode and the composite solid electrolyte; by cooling and solidifying the second trans-crystalline solidified liquid, a second trans-gauche isomeric plastic crystal layer is constructed between the composite solid electrolyte and the negative electrode; the first trans-crystalline solidified liquid includes 82-91 wt % of trans-gauche isomeric plastic crystals and 9-18 wt % of lithium salt; the composition of the second trans-crystalline solidified liquid is: 82-91 wt % of trans-gauche isomeric plastic crystal, 8-17 wt % of lithium salt and 0.1-3% of additive; the trans-gauche isomeric plastic crystal is one or more of malononitrile, succinonitrile (SN), pentanedionitrile (GN), adiponitrile (ADN) and heptanedionitrile, and the additive is one or more of fluoroethylene carbonate (FEC), polyacrylonitrile (PAN) and lithium nitrate (LiNO₃).

Further, the lithium salt is one or more of lithium bis-trifluoromethane sulfonyl imide (LiTFSI), lithium perchlorate (LiClO₄), lithium bis-fluorosulfonyl imide (LiFSI), lithium bisoxalate borate (LiBOB), lithium difluoroacetate borate (LiDFOB), lithium hexafluorophosphate (LiPF₆) and lithium tetrafluoroborate (LiBF₄).

According to the method for improving the interface of composite solid electrolyte in situ provided by the application, in the constructed trans-gauche isomeric plastic crystal layer, lithium salt is easy to dissociate, lithium ion migrates faster, and physical solidification from liquid state to solid state may effectively reduce the interface resistance; at the same time, trans-gauche isomeric plastic crystals contain a large number of polar groups, which may reduce the crystallinity of the composite membrane interface when contacting with the composite solid electrolyte membrane, further promote the transmission of lithium ions, reduce the resistance of the battery as a whole, and promote the battery dynamics.

A method for improving the interface of composite solid electrolyte in situ specifically includes the following steps:
S1, preparing a first trans-crystalline solidified liquid and a second trans-crystalline solidified liquid;
mixing 82-91 wt % of trans-gauche isomeric plastic crystals with 9-18 wt % of lithium salt, melting at 50-100° C., fully stirring and mixing, cooling to room temperature, and solidifying the liquid into a colloidal or solid state to obtain a first solidified liquid of trans-crystallines;
mixing 82-91 wt % of trans-gauche isomeric plastic crystal, 8-17 wt % of lithium salt and 0.1-3% of additive, melting at 50-100° C., fully stirring and mixing, cooling to room temperature, and solidifying the liquid into colloidal or solid state to obtain the second solidified liquid of trans-crystalline;
the trans-gauche isomeric plastic crystal is one or more of malononitrile, succinonitrile (SN), pentanedionitrile (GN), adiponitrile (ADN) and heptanedionitrile, and the additive is one or more of fluoroethylene carbonate (FEC), polyacrylonitrile (PAN) and lithium nitrate (LiNO₃); the lithium salt is one or more of lithium bis-trifluoromethane sulfonyl imide (LiTFSI), lithium perchlorate (LiClO₄), lithium bis-fluorosulfonyl imide (LiFSI), lithium bisoxalate borate (LiBOB), lithium difluoroxalate borate (LiDFOB), lithium hexafluorophosphate (LiPF₆) and lithium tetrafluoroborate (LiBF₄);
S2, preparing a composite solid electrolyte;
S3, preparing a positive electrode;
S4, heating the first solidified liquid of trans crystal obtained in S1 to 50-100° C., melting it into a liquid state, then dripping it onto the positive electrode prepared in S3, in which the dripping amount is 3-15 uL/cm², cooling to room temperature, solidifying to form a first trans-gauche isomeric plastic crystal layer, and then covering the first trans-gauche isomeric plastic crystal layer with the composite solid electrolyte prepared in S2;
S5, heating the second trans-crystalline solidified liquid obtained in S1 to 50-100° C., melting it into a liquid state, and then dripping it onto the composite solid electrolyte in S4, in which the dripping amount is 3-15 uL/cm², cooling to room temperature and solidifying to form a second trans-gauche isomeric plastic crystal layer, then covering the negative electrode on the second trans-gauche isomeric plastic crystal layer, and encapsulating the battery;
S6, letting the battery encapsulated in S5 stand for 1-2 h, then putting it in an oven at 50-100° C. for 5-20 min, taking it out, and then cooling it at room temperature for curing, so that the interface of composite solid electrolyte may be improved, and the composite solid battery with improved interface may be obtained.

Further, the process of preparing the composite solid electrolyte in S2 is as follows: mixing the organic polymer, lithium salt and inorganic ceramics according to the mass ratio of 1:(0.5-1):(0.15-1), dissolving the obtained mixed powder in 5-8 times of the mass of the solvent, fully stirring, coating on the glass plate or PTFE plate by tape casting, drying at 40-100° C., and drying. Among them, the organic polymer is polyethylene oxide (PEO), polyacrylonitrile (PAN), polyvinylidene fluoride (PVDF), polymethylmethacrylate (PMMA), polytetrafluoroethylene (PTFE) or polyvinyl alcohol (PVA), Optionally polyacrylonitrile (PAN) or polyvinylidene fluoride (PVDF). Inorganic ceramics are one or more of garnet-type, perovskite-type or NASICON-type solid electrolytes. Garnet-type solid electrolytes include Li₇La₃Zr₂O₁₂ or doped derivatives of Li₇La₃Zr₂O₁₂, perovskite-type solid electrolytes are Li₃ₓLa_{2/3-x}Ti₃O₃, and NASICON-type solid electrolytes are one of LATP and LAGP. The lithium salt is one or two of lithium bis-trifluoromethane sulfonyl imide (LiTFSI), lithium perchlorate (LiClO₄), lithium bis-fluorosulfonyl imide (LiFSI), lithium bisoxalate borate (LiBOB), lithium difluoroxalate borate (LiDFOB), lithium hexafluorophosphate (LiPF₆) and lithium tetrafluoroborate (LiBF₄). The solvent is dimethylformamide (DMF), acetonitrile (ACN), N-methylpyrrolidone (NMP) or acetone, optionally dimethylformamide (DMF).

Further, in S3, the positive electrode is obtained by mixing 80-90 wt % of positive electrode active material, 5-10 wt % of conductive agent and 5-10 wt % of polymer binder, in which the positive electrode active material is LiFePO₄, LiCoO₂, LiNi_{0.8}Co_{0.1}Mn_{0.1}O₂(NCM811), LiNi_{0.5}Co_{0.2}Mn_{0.3}O₂(NCM the conductive agent is one or more of conductive carbon black SuperP, Ketjen Black and carbon nanotubes (CNTs), and the polymer binder is one or more of polyvinylidene fluoride (PVDF), polytetrafluoroethylene (PTFE) and polyethylene oxide (PEO).

Further, the negative electrode in S5 is a metal lithium, lithium copper alloy, lithium aluminum alloy, lithium silicon alloy, lithium tin alloy or silicon carbon negative electrode.

Optionally, in S1, the trans-gauche isomeric plastic crystal is succinonitrile (SN), the lithium salt is LiTFSI or LiTFSI-LiDFOB double salt system, and the additive is one or two of fluoroethylene carbonate (FEC), polyacrylonitrile (PAN) and lithium nitrate (LiNO₃).

Optionally, in S4, the heating temperature of the first trans crystal curing solution is 60-80° C., and the holding time in S6 is 8-10 min.

In the method for improving the interface of composite solid electrolyte in situ provided by the application, the solidified liquid of trans crystal is rich in a large number of polar groups, and has the trans-gauche isomerism characteristic of central rotation, in which the strong polar groups have strong attraction to lithium ions, and the central symmetric structure may make itself rotate and transform, thus enhancing the ability of dissociating lithium salts. As shown in the figure below, it is a schematic diagram of the dissociation of lithium salt from the solidified liquid of trans crystal:

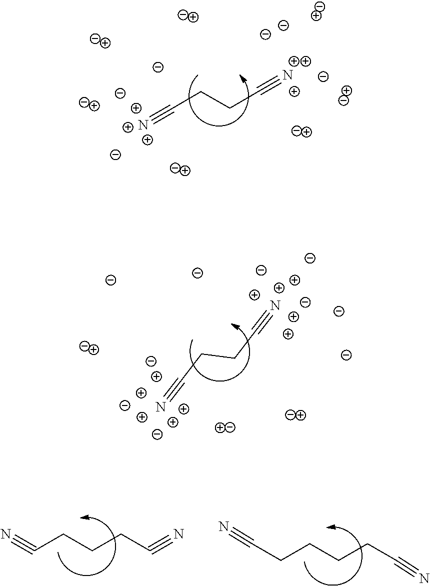

At the same time, the trans crystal solidified liquid is rich in a large number of polar groups, and the trans-gauche isomerism characteristic of the center rotation makes it interact with polar groups in polymers, disrupting the arrangement of polymers at the interface, reducing the crystallinity at the interface and increasing its amorphous region, thus promoting the transmission of lithium ions as shown in the figure below:

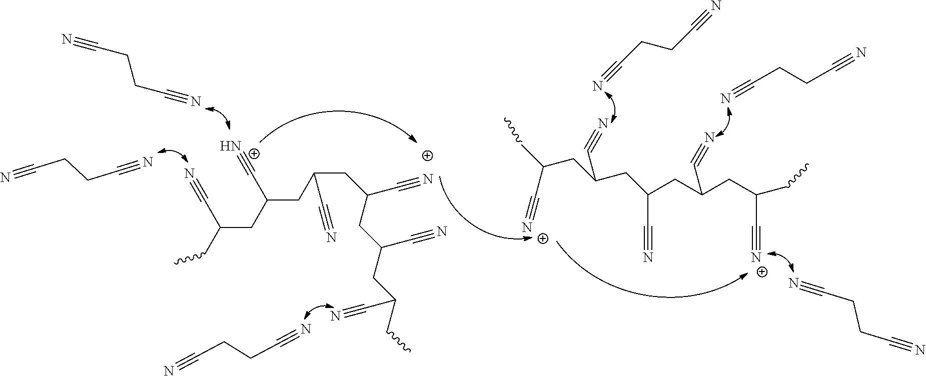

In the process of assembling the battery, the solidified liquid of trans crystal with high polarity and high dielectric constant fully contacts with the composite solid electrolyte, which reduces the crystallinity of the composite solid electrolyte. The single polymer has high crystallinity, and the movement distance of lithium ions through the chain segment is long, as shown in the following figure:

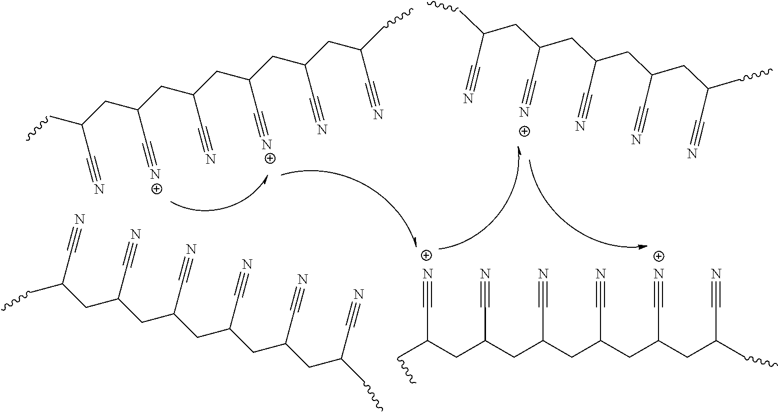

Compared with the prior art, the application has the advantages that:
1. The application provides a method for improving the interface of composite solid electrolyte in situ, which improves the interface of solid electrolyte by constructing a trans-gauche isomeric plastic crystal layer. The trans-gauche isomeric molecules may rotate around the central C atom or C—C bond, and the constructed trans-gauche isomeric plastic crystal has a strong dissociation property to lithium salt, and the ion conductivity of the battery may be improved as a whole by combining with the high ion conductivity of lithium salt, and the interface resistance between composite solid electrolyte and electrode may be reduced.
2. The application provides a method for improving the interface of composite solid electrolyte in situ. By selecting appropriate trans-gauche isomeric plastic crystals, lithium salts and additives, the content of trans-gauche isomeric plastic crystals, lithium salts and additives is comprehensively regulated to obtain trans-crystalline solidified liquid. The curing solution has a large dielectric constant and contains a large number of polar groups, which may reduce the crystallinity of the composite solid electrolyte at the interface and promote the transmission of lithium ions, thus greatly reducing the impedance of the battery. At the same time, simple physical curing may also promote the close contact at the interface.
3. The method for improving the interface of composite solid electrolyte in situ provided by the application is simple in process, small in temperature span, free of flammable electrolyte, and environment-friendly. The capacity attenuation of the composite solid battery after the interface modification is suppressed, and the cycle stability is greatly enhanced.

### BRIEF DESCRIPTION OF THE DRAWINGS

FIG. 1 is a schematic diagram of the structure of the composite solid-state battery after the interface of the composite solid-state electrolyte is improved in situ. Among them, 1 is a negative current collector, 2 is a lithium metal negative electrode, 3 is a second trans crystal curing solution, 4 is a composite solid electrolyte membrane, 5 is the first trans crystal curing solution, 6 is a positive active material, 7 is a conductive agent, 8 is a binder, and 9 is a positive current collector.

FIG. 2 is a scanning electron microscope (SEM) diagram of the composite solid electrolyte of Embodiment 1.

FIG. 3 is a comparison of EIS impedance of composite solid-state batteries in Embodiment 3 and Comparative examples 1-2.

FIG. 4 is the charge-discharge cycle curve of the composite solid-state battery of Embodiment 1 at 0.3 C.

FIG. 5 is the charge-discharge cycle curve of the composite solid-state battery of Comparative example 1 at 0.3 C.

FIG. 6 shows the charge-discharge cycle curve of the composite solid-state battery of Comparative example 2 at 0.3 C.

FIG. 7 is a flowing chart for a method for improving an interface of composite solid electrolyte in situ.

### DETAILED DESCRIPTION OF THE EMBODIMENTS

In order the technical scheme of the present application will be clearly and completely described below with reference to the drawings and embodiments. Obviously, the described embodiments are part of the embodiments of the present application, but not all of them.

### Embodiment 1

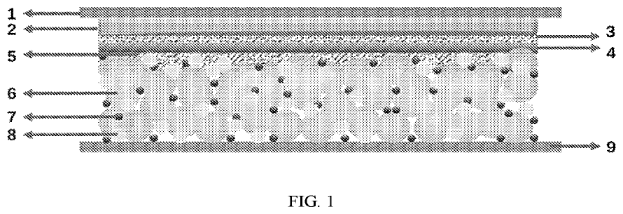

As shown in FIG. 1, it is a structural schematic diagram of the composite solid-state battery after the interface of the composite solid-state electrolyte is improved in situ, including a negative current collector 1, a high-capacity lithium metal negative electrode 2, a second trans-crystalline curing liquid 3, a composite solid electrolyte membrane 4, a first trans-crystalline curing liquid 5, a positive active material 6, a conductive agent 7, a binder 8 and a positive current collector 9. The positive current collector 9 is aluminum foil, and the negative current collector 1 is steel sheet.

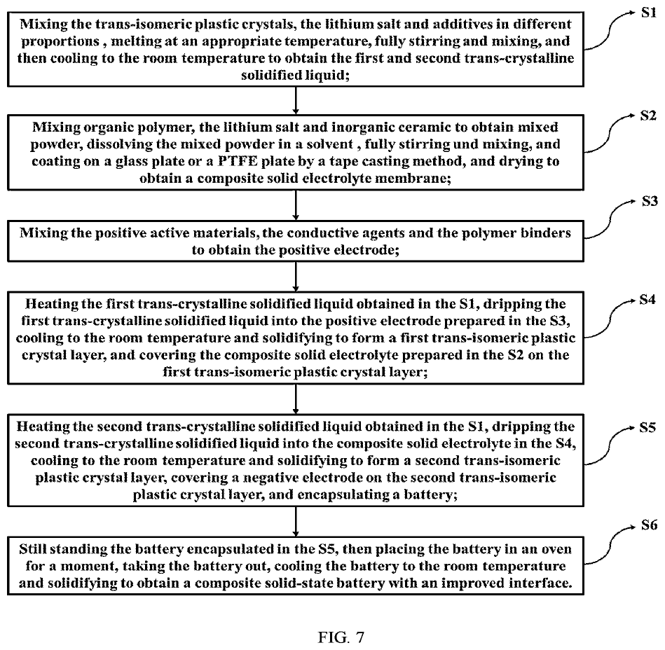

As shown in FIG. 7, a method for improving the interface of composite solid electrolyte in situ specifically includes the following steps:
S1, preparing a first trans-crystalline solidified liquid and a second trans-crystalline solidified liquid;
87.5 wt % of succinonitrile (SN) and 12.5 wt % of lithium bis-trifluoromethane sulfonyl imide (LiTFSI) were mixed, stirred at 80° C. for 10 minutes at a speed of 300 rpm, so that LiTFSI and SN were fully and uniformly mixed to obtain a clear liquid, which was cooled at room temperature for 10 minutes, and the liquid was solidified into a colloidal state, thus obtaining the first trans crystal solidified liquid;
87.5 wt % of succinonitrile (SN), 12.2 wt % of lithium bis-trifluoromethane sulfonyl imide (LiTFSI) and 0.3 wt % of fluoroethylene carbonate (FEC) were mixed, and stirred at 80° C. for 10 minutes at a speed of 300 rpm, so that LiTFSI, SN and FEC were fully and uniformly mixed to obtain a clear liquid, which was cooled at room temperature for 10 minutes, and the liquid solidified into a colloidal state to obtain the second solution.
S2, preparing a composite solid electrolyte;
polyacrylonitrile (PAN), lithium bis-trifluoromethane sulfonyl imide (LiTFSI) and Li_{6.4}La₃Zr_{1.4}Ta_{0.6}O₁₂ garnet electrolyte were mixed according to the mass ratio of 1:1:0.2, and the obtained mixed powder was dissolved in 5 times the mass of dimethylformamide (DMF). After fully stirring, it was coated on a glass plate or PTFE plate by tape casting, dried in a vacuum oven at 80° C.
S3, preparing a positive electrode;
LiFePO₄, conductive carbon black SuperP and polyvinylidene fluoride PVDF are dissolved in equal volume of N-methylpyrrolidone (NMP) according to the mass ratio of 8:1:1, fully ground under an infrared lamp for 30 min, then evenly coated on aluminum foil, dried and cut into pieces to obtain a positive electrode;
S4, heating the first solidified liquid of trans crystal obtained in S1 to 80° C., melting it into a liquid state, and then dripping it onto the positive electrode prepared in S3 with the dripping amount of 5 uL/cm², cooling to room temperature and solidifying to form a first trans-gauche isomeric plastic crystal layer, and then covering the composite solid electrolyte membrane prepared in S2 on the first trans-isomeric plastic crystal layer;
S5, heating the second trans-gauche crystalline solidified liquid obtained in S1 to 80° C., melting it into a liquid state, then dripping it onto the composite solid electrolyte in S4, with the dripping amount of 5 uL/cm², cooling to room temperature and solidifying to form a second trans-gauche isomeric plastic crystal layer, then covering the second trans-gauche isomeric plastic crystal layer with metallic lithium sheet, and encapsulating the battery;
S6, letting the battery encapsulated in S5 stand for 1 h, then putting it in an oven at 70° C. for 10 min, taking it out, and cooling it at room temperature for curing, so that the interface of composite solid electrolyte may be improved, and the composite solid battery with improved interface may be obtained.

### Embodiment 2

Compared with Embodiment 1, Embodiment 2 is different in that in S1, 91 wt % of succinonitrile (SN) and 9 wt % of lithium perchlorate (LiClO₄) are mixed, stirred at 80° C. for 10 minutes at a speed of 300 rpm, so that LiClO₄ and SN are fully and uniformly mixed to obtain a clear liquid, which is cooled at room temperature for 10 minutes, and the liquid is solidified into a colloidal state to obtain the first solidified liquid of trans crystal. 91 wt % of succinonitrile (SN), 8.8 wt % of lithium perchlorate (LiClO₄) and 0.2% of fluoroethylene carbonate (FEC) were mixed, and stirred at 80° C. for 10 min at a speed of 300 rpm, so that LiClO₄, SN and FEC were fully and uniformly mixed to obtain a clear liquid, which was cooled at room temperature for 10 min, and the liquid was solidified into a colloidal state to obtain the second trans crystal solidified liquid. In S2, lithium perchlorate (LiClO₄) was selected as lithium salt, and the mass ratio of polyacrylonitrile (PAN), lithium perchlorate (LiClO₄) and Li_{6.4}La₃Zr_{1.4}Ta_{0.6}O₁₂ garnet electrolyte was 1:0.5:0.16. In S4, the heating temperature is 90° C. In S6, the temperature in the oven is kept for 20 min. Other steps are exactly the same as those in Embodiment 1.

### Embodiment 3

Compared with Embodiment 1, the difference of Embodiment 3 is that in S1, 91 wt % of succinonitrile (SN) and 9 wt % of (LiTFSI+LiDFOB) were mixed, with the mass ratio of LiTFSI:LiDFOB=6:4, and stirred at 80° C. for 10 min at 300 rpm, so that LiTFSI, LiDFOB and SN were fully and uniformly mixed. 91 wt % of succinonitrile (SN), 8.8 wt % of (LiTFSI+LiDFOB) and 0.2% of fluoroethylene carbonate (FEC) were mixed, with the mass ratio of LiTFSI:LiFOB=6:4, and stirred at 80° C. for 10 min at 300 rpm, so that LiTFSI, LiFOB, SN and FEC were fully and evenly mixed. Other steps are exactly the same as those in Embodiment 1.

### Comparative Example 1

S1, preparing a composite solid electrolyte;
polyacrylonitrile (PAN), lithium perchlorate (LiClO₄) and Li_{6.4}La₃Zr_{1.4}Ta_{0.6}O₁₂ garnet electrolyte were mixed according to the mass ratio of 1:0.5:0.16, and the obtained mixed powder was dissolved in 5 times the mass of dimethylformamide (DMF). After fully stirring, it was coated on glass plate or PTFE plate by tape casting method, dried in vacuum oven at 80° C., and put in gloves.
S2, preparing a positive electrode;
LiFePO₄, conductive carbon black SuperP and polyvinylidene fluoride PVDF are dissolved in equal volume of N-methylpyrrolidone (NMP) according to the mass ratio of 8:1:1, fully ground under an infrared lamp for 30 min, then evenly coated on aluminum foil, dried and cut into pieces to obtain a positive electrode;
S3, covering the PAN@LiClO₄@LLZTO composite solid electrolyte membrane obtained in S1 on the positive electrode prepared in S2;
S4, covering the metal lithium sheet on the composite solid electrolyte membrane, and encapsulating the battery;
S5, putting the battery encapsulated in S4 in an oven at 80° C. for 30 min, and improving the interface between the composite solid electrolyte membrane and the two electrodes through appropriate high temperature to obtain the composite solid battery without interface modification.

### Comparative Example 2

Compared with Comparative example 1, Comparative example 2 is different in that during the process of encapsulating the battery in S3 and S4, 5 uL of commercial LB002 electrolyte was dripped on the positive electrode, and then the PAN@LiClO₄@LLZTO composite solid electrolyte membrane was covered on it; then, 5 uL of commercial LB002 electrolyte was dripped on the composite solid electrolyte membrane, and then the metal lithium negative plate was covered. The storage time of the encapsulated battery in S5 is 12 h. Other steps are exactly the same as those of Comparative example 1.

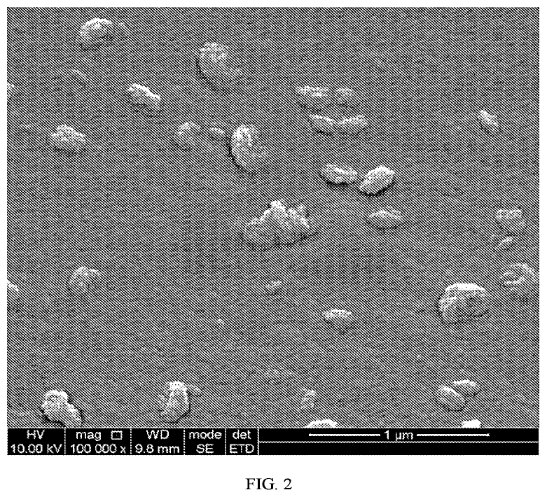

FIG. 2 is the scanning electron microscope (SEM) picture of the composite solid electrolyte of Embodiment 1. It may be seen from FIG. 2 that the particle size of Li_{6.4}La₃Zr_{1.4}Ta_{0.6}O₁₂ garnet solid electrolyte is between 200-400 nm and 400 nm, and it is uniformly dispersed in the polymer @ lithium salt matrix. The composite solid electrolyte is compact and pore-free, and the solidified liquid can only contact with its surface, but can't penetrate into it.

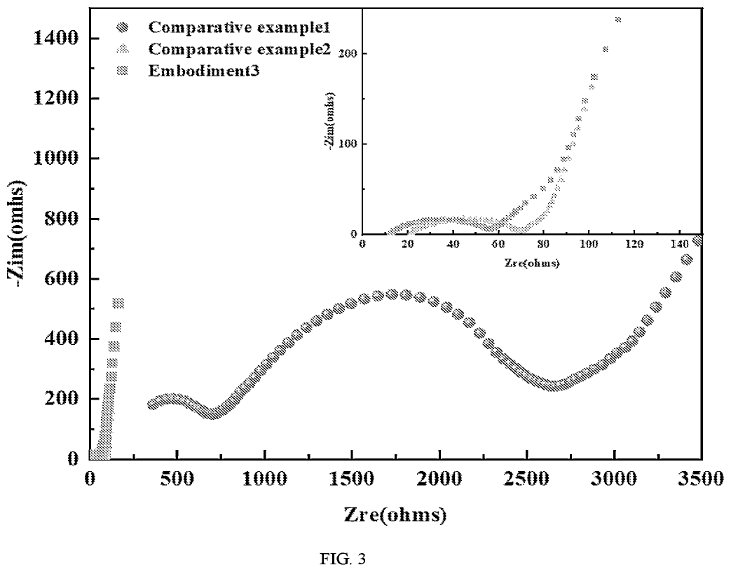

The interface impedance of the composite solid-state batteries prepared in Embodiment 3 and Comparative examples 1-2 was tested, and the results are shown in FIG. 3. As can be seen from FIG. 3, the pure composite solid electrolyte has a large interfacial resistance without modification, that is, the impedance of Embodiment 1 is larger, and the interfacial resistance decreases significantly after dropping electrolyte, that is, the interfacial resistance of Embodiment 2 is smaller. However, the interface impedance of the trans-gauche isomeric plastic crystal after in-situ improvement in the embodiment of the application is significantly reduced, and the effect of electrolyte modification can be achieved. Therefore, by reasonably adjusting the contents of trans-gauche isomeric plastic crystals, lithium salt and additives, the interface impedance of the cured solution of trans-crystallines can be lower than that of the interface modified by electrolyte. This trans-gauche isomeric plastic crystal has strong mobility, contains a large number of polar groups, and has strong dissociative ability to lithium salt. At the same time, it can also reduce the crystallinity of the interface of composite solid electrolyte and promote the movement of lithium ions. The specific interface resistance values are shown in Table 1.

TABLE 1
Interfacial impedance of composite solid-state batteries
of various embodiments and comparative examples

| | | | | Compara- | Compara- |
|---|---|---|---|---|---|
| | Embodi- | Embodi- | Embodi- | tive | tive |
| | ment 1 | ment 2 | ment 3 | example 1 | example 2 |
| Interfacial | 82 | 97 | 48 | 2150 | 51 |
| impedance | | | | | |
| (Ω) | | | | | |

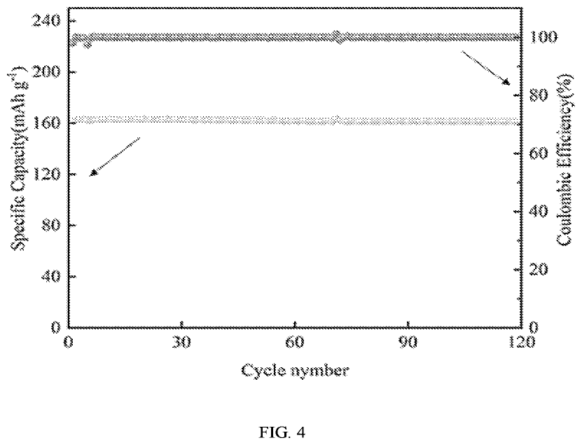

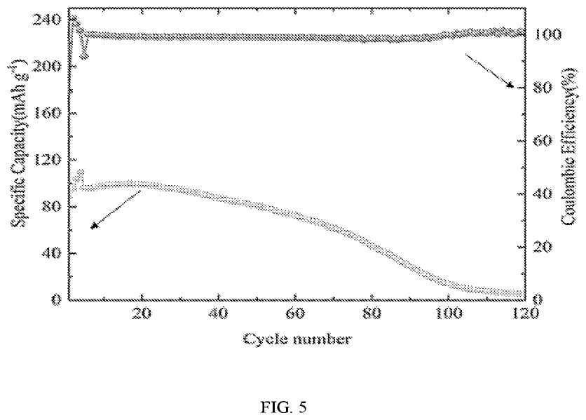

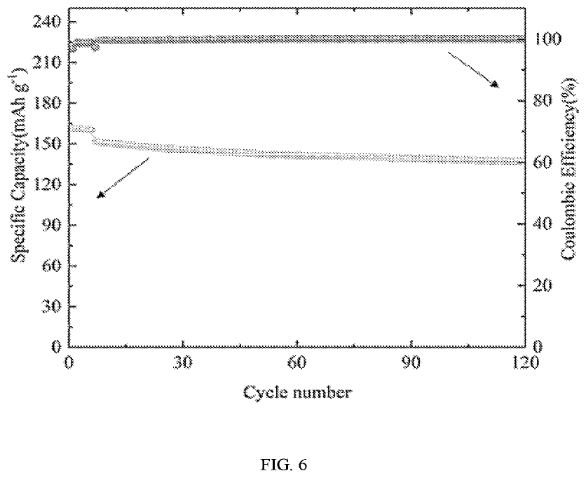

The composite solid-state batteries prepare in Embodiment 1 an Comparative examples 1-2 are characterized by 0.3 C charge-discharge cycle, and the results are shown in FIGS. 4-6. As may be seen from FIGS. 4-6, the first discharge capacity of Embodiment 1, Comparative example 1 and Comparative example 2 is 161.4, 87.9 and 160.7 mAh/g, respectively, and the capacity retention rates after 120 cycles are 99.75, 6.4 and 85.4%, respectively. Therefore, the application greatly reduces the interface resistance, inhibits the capacity attenuation of the battery, and improves the cycle stability through the in-situ modification of the trans-gauche isomeric plastic crystal.

The above-mentioned embodiments and comparative examples only describe the preferred mode of the application, but do not limit the scope of the application. On the premise of not departing from the design spirit of the application, ordinary technicians in the field may make improvements and optimizations within the scope of the application, and these improvements and optimizations should also be regarded as the protection scope of the application.

What is claimed is:

1. A method for improving an interface of composite solid electrolyte in situ, comprising:
constructing a first trans-gauche isomeric plastic crystal layer between a positive electrode and the composite solid electrolyte by cooling and solidifying a first trans-crystalline solidified liquid, and
constructing a second trans-gauche isomeric plastic crystal layer between the composite solid electrolyte and a negative electrode by cooling and solidifying a second trans-crystalline solidified liquid,
wherein the first trans-crystalline solidified liquid comprises 82-91 wt % of trans-gauche isomeric plastic crystals and 9-18 wt % of lithium salt, and the second trans-crystalline solidified liquid comprises 82-91 wt % of the trans-gauche isomeric plastic crystals, 8-17 wt % of the lithium salt and 0.1-3% of additives, and
wherein the trans-gauche isomeric plastic crystals are one or more of malononitrile, succinonitrile, pentanedionitrile, adiponitrile and heptanedionitrile, and the additives are one or more of fluoroethylene carbonate, polyacrylonitrile and lithium nitrate.

2. The method for improving the interface of the composite solid electrolyte in situ according to claim 1, wherein the lithium salt is one or more of lithium bis-trifluoromethane sulfonyl imide, lithium perchlorate, lithium bis-fluorosulfonyl imide, lithium bis-oxalate borate, lithium difluoroacetate borate, lithium hexafluorophosphate and lithium tetrafluoroborate.

3. A method for improving an interface of composite solid electrolyte in situ, comprising:
S1, preparing a first trans-crystalline solidified liquid and a second trans-crystalline solidified liquid:
mixing 82-91 wt % of trans-gauche isomeric plastic crystals and 9-18 wt % of lithium salt, melting at 50-100° C., fully stirring and mixing, and then cooling to room temperature to obtain the first trans-crystalline solidified liquid;
mixing 82-91 wt % of the trans-gauche isomeric plastic crystals, 8-17 wt % of the lithium salt and 0.1-3% of additives, melting at 50-100° C., fully stirring and mixing, and then cooling to the room temperature to obtain the second trans-crystalline solidified liquid;
S2, preparing the composite solid electrolyte;
S3, preparing a positive electrode;
S4, heating the first trans-crystalline solidified liquid obtained in the S1 to 50-100° C., dripping the first trans-crystalline solidified liquid into the positive electrode prepared in the S3, with a dripping amount of 3-15 uL/cm², cooling to the room temperature and solidifying to form a first trans-gauche isomeric plastic crystal layer, and covering the composite solid electrolyte prepared in the S2 on the first trans-gauche isomeric plastic crystal layer;
S5, heating the second trans-crystalline solidified liquid obtained in the S1 to 50-100° C., dripping the second trans-crystalline solidified liquid into the composite solid electrolyte in the S4, with the dripping amount of 3-15 uL/cm², cooling to the room temperature and solidifying to form a second trans-gauche isomeric plastic crystal layer, covering a negative electrode on the second trans-gauche isomeric plastic crystal layer, and encapsulating a battery; and
S6, still standing the battery encapsulated in the S5, then placing the battery in an oven at 50-100° C. for 5-20 min, taking the battery out, cooling the battery to the room temperature and solidifying to obtain a composite solid-state battery with an improved interface.

4. The method for improving the interface of the composite solid electrolyte in situ according to claim 3, wherein in the S1,
the trans-gauche isomeric plastic crystals are one or more of malononitrile, succinonitrile, pentanedionitrile, adiponitrile and heptanedionitrile,
the additives are one or more of fluoroethylene carbonate, polyacrylonitrile and lithium nitrate, and
the lithium salt is one or more of lithium bis-trifluoromethane sulfonyl imide, lithium perchlorate, lithium bis-fluorosulfonyl imide, lithium bis-oxalate borate, lithium difluoroacetate borate, lithium hexafluorophosphate and lithium tetrafluoroborate.

5. The method for improving the interface of the composite solid electrolyte in situ according to claim 3, wherein preparing the composite solid electrolyte in the S2 comprises:
mixing organic polymer, the lithium salt and inorganic ceramic according to a mass ratio of 1:(0.5-1):(0.15-1) to obtain mixed powder, dissolving the mixed powder in a solvent with 5-8 times mass of the mixed powder, fully stirring und mixing, and coating on a glass plate or a PTFE plate by a tape casting method, and drying at 40-100° C. to obtain a composite solid electrolyte membrane.

6. The method for improving the interface of the composite solid electrolyte in situ according to claim 5, wherein
the organic polymer is polyethylene oxide, polyacrylonitrile, polyvinylidene fluoride, polymethyl methacrylate, polytetrafluoroethylene or polyvinyl alcohol,
the inorganic ceramic is one or two of garnet solid electrolyte, perovskite solid electrolyte and NASICON solid electrolyte,
the lithium salt is lithium bis-trifluoromethane sulfonyl imide, lithium perchlorate, lithium bis-fluorosulfonyl imide, lithium bis-oxalate borate, lithium difluoroacetate borate, lithium hexafluorophosphate and lithium tetrafluoroborate, and
the solvent is dimethylformamide, acetonitrile, N-methylpyrrolidone or acetone.

7. The method for improving the interface of the composite solid electrolyte in situ according to claim 3, wherein in the S3,
the positive electrode is obtained by mixing 80-90 wt % of positive active materials, 5-10 wt % of conductive agents and 5-10 wt % of polymer binders, and
the active materials are one or more of LiFePO₄, LiCoO₂, LiNi_{0.8}Co_{0.1}Mn_{0.1}O₂ and LiNi_{0.5}Co_{0.2}Mn_{0.3}O₂, the conductive agents are one or more of conductive carbon black SuperP, Ketjen Black and carbon nanotubes, and the polymer binders are one or more of polyvinylidene fluoride, polytetrafluoroethylene and polyethylene oxide.

8. The method for improving the interface of the composite solid electrolyte in situ according to claim 3, wherein the negative electrode in the S5 is metal lithium, lithium copper alloy, lithium aluminum alloy, lithium silicon alloy, lithium tin alloy or a silicon carbon negative electrode.
